(19) United States
(12) Patent Application Publication
(10) Pub. No.: US 2007/0208109 A1
(43) Pub. Date: Sep. 6, 2007

(54) Additive building material mixtures containing swellable polymeric formations

(75) Inventors: Holger Kautz, Hanau (DE); Jan Hendrik Schattka, Hanau (DE); Gerd Loehden, Hanau (DE); Joachlm Venzmer, Essen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GBMH & CO., KG, Darmstadt (DE)

(21) Appl. No.: 11/387,805

(22) Filed: Mar. 24, 2006

(30) Foreign Application Priority Data
Mar. 1, 2006 (DE) 10 2006 009 841.2

(51) Int. Cl. C04B 24/26

(52) U.S. Cl. 524/2

(57) ABSTRACT

The present invention relates to the use of base-swellable polymeric formations in hydraulically setting building material mixtures for the purpose of enhancing their frost resistance and cyclical freeze/thaw durability.

The present invention relates to the use of polymeric microparticles in hydraulically setting building material mixtures for the purpose of enhancing their frost resistance and cyclical freeze/thaw durability.

Concrete is an important building material and is defined by DIN 1045 (07/1988) as artificial stone formed by hardening from a mixture of cement, aggregate and water, together where appropriate with concrete admixtures and concrete additions. One way in which concrete is classified is by its subdivision into strength groups (BI-BII) and strength classes (B5-B55). Adding gas-formers or foam-formers to the mix produces aerated concrete or foamed concrete (Römpp Lexikon, 10th ed., 1996, Georg Thieme Verlag).

Concrete has two time-dependent properties. Firstly, by drying out, it undergoes a reduction in volume that is termed shrinkage. The majority of the water, however, is bound in the form of water of crystallization. Concrete, rather than drying, sets: that is, the initially highly mobile cement paste (cement and water) starts to stiffen, becomes rigid, and, finally, solidifies, depending on the timepoint and progress of the chemical/mineralogical reaction between the cement and the water, known as hydration. As a result of the water-binding capacity of the cement it is possible for concrete, unlike quicklime, to harden and remain solid even under water. Secondly, concrete undergoes deformation under load, known as creep.

The freeze/thaw cycle refers to the climatic alternation of temperatures around the freezing point of water. Particularly in the case of mineral-bound building materials such as concrete, the freeze/thaw cycle is a mechanism of damage. These materials possess a porous, capillary structure and are not watertight. If a structure of this kind that is full of water is exposed to temperatures below 0° C., then the water freezes in the pores. As a result of the density anomaly of water, the ice then expands. This results in damage to the building material. Within the very fine pores, as a result of surface effects, there is a reduction in the freezing point. In micropores water does not freeze until below −17° C. Since, as a result of freeze/thaw cycling, the material itself also expands and contracts, there is additionally a capillary pump effect, which further increases the absorption of water and hence, indirectly, the damage. The number of freeze/thaw cycles is therefore critical with regard to damage.

Decisive factors affecting the resistance of concrete to frost and to cyclical freeze/thaw under simultaneous exposure to thawing agents are the imperviousness of its microstructure, a certain strength of the matrix, and the presence of a certain pore microstructure. The microstructure of a cement-bound concrete is traversed by capillary pores (radius: 2 μm-2 mm) and gel pores (radius: 2-50 nm). Water present in these pores differs in its state as a function of the pore diameter. Whereas water in the capillary pores retains its usual properties, that in the gel pores is classified as condensed water (mesopores: 50 nm) and adsorptively bound surface water (micropores: 2 nm), the freezing points of which may for example be well below −50° C. [M. J. Setzer, Interaction of water with hardened cement paste, Ceramic Transactions 16 (1991) 415-39]. Consequently, even when the concrete is cooled to low temperatures, some of the water in the pores remains unfrozen (metastable water). For a given temperature, however, the vapor pressure over ice is lower than that over water. Since ice and metastable water are present alongside one another simultaneously, a vapor-pressure gradient develops which leads to diffusion of the still-liquid water to the ice and to the formation of ice from said water, resulting in removal of water from the smaller pores or accumulation of ice in the larger pores. This redistribution of water as a result of cooling takes place in every porous system and is critically dependent on the type of pore distribution.

The artificial introduction of microfine air pores in the concrete hence gives rise primarily to what are called expansion spaces for expanding ice and ice-water. Within these pores, freezing water can expand or internal pressure and stresses of ice and ice-water can be absorbed without formation of microcracks and hence without frost damage to the concrete. The fundamental way in which such air-pore systems act has been described, in connection with the mechanism of frost damage to concrete, in a large number of reviews [Schulson, Erland M. (1998) Ice damage to concrete. CRREL Special Report 98-6; S. Chatterji, Freezing of air-entrained cement-based materials and specific actions of air-entraining agents, Cement & Concrete Composites 25 (2003) 759-65; G. W. Scherer, J. Chen & J. Valenza, Methods for protecting concrete from freeze damage, U.S. Pat. No. 6,485,560 B1 (2002); M. Pigeon, B. Zuber & J. Marchand, Freeze/thaw resistance, Advanced Concrete Technology 2 (2003) 11/1-11/17; B. Erlin & B. Mather, A new process by which cyclic freezing can damage concrete—the Erlin/Mather effect, Cement & Concrete Research 35 (2005) 1407-11].

A precondition for improved resistance of the concrete on exposure to the freezing and thawing cycle is that the distance of each point in the hardened cement from the next artificial air pore does not exceed a defined value. This distance is also referred to as the “Powers spacing factor” [T. C. Powers, The air requirement of frost-resistant concrete, Proceedings of the Highway Research Board 29 (1949) 184-202]. Laboratory tests have shown that exceeding the critical “Power spacing factor” of 500 μm leads to damage to the concrete in the freezing and thawing cycle. In order to achieve this with a limited air-pore content, the diameter of the artificially introduced air pores must therefore be less than 200-300 μm [K. Snyder, K. Natesaiyer & K. Hover, The stereological and statistical properties of entrained air voids in concrete: A mathematical basis for air void systems characterization, Materials Science of Concrete VI (2001) 129-214].

The formation of an artificial air-pore system depends critically on the composition and the conformity of the aggregates, the type and amount of the cement, the consistency of the concrete, the mixer used, the mixing time, and the temperature, but also on the nature and amount of the agent that forms the air pores, the air entrainer. Although these influencing factors can be controlled if account is taken of appropriate production rules, there may nevertheless be a multiplicity of unwanted adverse effects, resulting ultimately in the concrete's air content being above or below the desired level and hence adversely affecting the strength or the frost resistance of the concrete.

Artificial air pores of this kind cannot be metered directly; instead, the air entrained by mixing is stabilized by the addition of the aforementioned air entrainers [L. Du & K. J. Folliard, Mechanism of air entrainment in concrete, Cement & Concrete Research 35 (2005) 1463-71]. Conventional air entrainers are mostly surfactant-like in structure and break up the air introduced by mixing into small air bubbles having a diameter as far as possible of less than 300 μm, and stabilize them in the wet concrete microstructure. A distinction is made here between two types.

One type—for example sodium oleate, the sodium salt of abietic acid or Vinsol resin, an extract from pine roots—reacts with the calcium hydroxide of the pore solution in the cement paste and is precipitated as insoluble calcium salt. These hydrophobic salts reduce the surface tension of the water and collect at the interface between cement particle, air and water. They stabilize the microbubbles and are therefore encountered at the surfaces of these air pores in the concrete as it hardens.

The other type—for example sodium lauryl sulfate (SDS) or sodium dodecyl-phenylsulphonate—reacts with calcium hydroxide to form calcium salts which, in contrast, are soluble, but which exhibit an abnormal solution behavior. Below a certain critical temperature the solubility of these surfactants is very low, while above this temperature their solubility is very good. As a result of preferential accumulation at the air/water boundary they likewise reduce the surface tension, thus stabilize the microbubbles, and are preferably encountered at the surfaces of these air pores in the hardened concrete.

The use of these prior-art air entrainers is accompanied by a host of problems [L. Du & K. J. Folliard, Mechanism of air entrainment in concrete, Cement & Concrete Research 35 (2005) 1463-71]. For example, prolonged mixing times, different mixer speeds and altered metering sequences in the case of ready-mix concretes result in the expulsion of the stabilized air (in the air pores).

The transporting of concretes with extended transport times, poor temperature control and different pumping and conveying equipment, and also the introduction of these concretes in conjunction with altered subsequent processing, jerking and temperature conditions, can produce a significant change in an air-pore content set beforehand. In the worst case this may mean that a concrete no longer complies with the required limiting values of a certain exposure class and has therefore become unusable [EN 206-1 (2000), Concrete—Part 1: Specification, performance, production and conformity].

The amount of fine substances in the concrete (e.g. cement with different alkali content, additions such as flyash, silica dust or colour additions) likewise adversely affects air entrainment. There may also be interactions with flow improvers that have a defoaming action, and hence expel air pores, but may also introduce them in an uncontrolled manner.

A relatively new possibility for improving the frost resistance and cyclical freeze/thaw durability is to achieve the air content by the admixing or solid metering of polymeric microparticles (hollow microspheres) [H. Sommer, A new method of making concrete resistant to frost and de-icing salts, Betonwerk & Fertigteiltechnik 9 (1978) 476-84]. Since the microparticles generally have particle sizes of less than 100 μm, they can also be distributed more finely and uniformly in the concrete microstructure than can artificially introduced air pores. Consequently, even small amounts are sufficient for sufficient resistance of the concrete to the freezing and thawing cycle. The use of polymeric microparticles of this kind for improving the frost resistance and cyclical freeze/thaw durability of concrete is already known from the prior art [cf. DE 2229094 A1, U.S. Pat. No. 4,057,526 B1, U.S. Pat. No. 4,082,562 B1, DE 3026719 A1]. The microparticles described therein are notable in particular for the fact that they possess a void smaller than 200 μm (in diameter) and that this hollow core consists of air (or a gaseous substance). This likewise includes porous microparticles from the 100 μm scale, which may possess a multiple of relatively small voids and/or pores.

The production of these core/shell microparticles is relatively complex, generally involving multistage syntheses, by emulsion polymerization or suspension polymerization, for example, which require, moreover, a swelling step during or after the actual microparticle production stage.

Superabsorbents have already been used occasionally in construction mixtures. Superabsorbents (further common names in the literature: hydrogel, polyelectrolyte gel, water-swellable polymer, water-absorbing polymer, superabsorbent material (SAM) or superabsorbent polymer (SAP)) are compounds having an ability to effect spontaneous and rapid absorption of large quantities of aqueous fluids. They are generally prepared by solution polymerization, until a gel is obtained. This gel is subsequently dried, comminuted mechanically, and screened [cf. Ullmann's Encyclopedia of Industrial Chemistry, Release 2006, 7th Edition, Markus Frank, “Superabsorbents”, DOI: 10.1002/14356007.f25_f01].

It has been found that, by virtue of their water storage capacity, superabsorbents are able to protect construction mixtures from self-dryout [Jensen, Ole Mejlhede; Hansen, Per Freiesleben “Water-entrained cement-based materials II. Experimental observations” Cement and Concrete Research (2002), 32(6), 973-978] and can be utilized for sealing leaks in concrete [Tsuji, Masanori; Koyano, Hiroshi; Okuyama, Atsushi; Isobe, Daisuke “Study on method of test for leakage through cracks of hardened concrete” Semento, Konkurito Ronbunshu (1999), 53 462-468].

Frost resistance and cyclical freeze/thaw durability has been improved, additionally, through the use of ground superabsorbents having an average particle size of 125 μm [Moennig, S., “Water saturated super-absorbent polymers used in high strength concrete” Otto Graf Journal (2005), 16, 193-202].

For the hollow microspheres and also the superabsorbents, however, relatively high levels of addition are needed in order to obtain values below the critical “Power spacing factors”, the reason for this lying at least partly in the large particle diameter of >100 μm. This fact, in combination with the comparatively high preparation costs, a result of the multistage preparation processes, have been detrimental to the establishment of these technologies on the market.

The object on which the present invention is based, therefore, was to provide a means of improving the frost resistance and cyclical freeze/thaw durability for hydraulically setting building material mixtures that develops its full activity even at relatively low levels of addition, and which, moreover, can be prepared easily and inexpensively. A further object was not, or not substantially, to impair the mechanical strength of the building material mixture as a result of said means.

It has now been found, surprisingly, that polymeric formations which are swollen using a base and comprise one or more monoethylenically unsaturated monomers and one or more crosslinkers are outstandingly suitable for achieving the stated object. In comparison to the prior art, the polymeric formations described here possess further advantageous properties:

A particularly attractive feature is that these polymeric formations can be prepared at very favorable cost in comparison to known microparticle systems. As a result of their relatively low size, dispersibility in the construction mixture is improved. This leads in turn to a significantly more homogeneous distribution of the polymeric formations in the construction mixture, leading automatically to a more favorable “Powers spacing factor”. The polymeric formations of the invention also function as small water-containing sponges, which counteract the self-dryout of the construction mixture. As a result of their significantly smaller particle diameter and the associated considerably larger specific surface area, however, they also give up the bound water markedly more rapidly to the surrounding construction mixture. Their activity in respect of frost resistance and cyclical freeze/thaw durability is therefore available much more quickly, as is manifested in a substantially better weathering factor.

The mode of action can be explained as follows: the swollen polymeric formations are initially present in homogeneous distribution in the construction mixture in the form of chambers which to start with are filled with water. As the construction mixture sets, the water is removed from the polymeric formations by the surrounding matrix, leaving small, air-filled chambers with the unswollen polymeric formation.

In the case of building material mixtures which are exposed very quickly after hardening to freezing/thawing, the advantage according to the invention is manifested above all in the weathering factor, which represents a qualitative assessment for the visible frost damage on the surface of a sample.

The polymeric formations of the invention are microparticles which are prepared preferably by emulsion polymerization and which may include further constituents. Without wishing to restrict the invention to this effect, these constituents may serve for stabilization and/or compatibilization.

The numerical values given refer, unless indicated otherwise, to the unswollen polymeric formations.

The polymeric formation comprises at least one polymer based on at least one monoethylenically unsaturated monomer containing an acid group. The acid groups of the monomer employed may be partly or fully neutralized, preferably partly neutralized. Reference is made in this context to DE 195 29 348, the disclosure content of which is hereby incorporated by reference and considered part of the present disclosure content.

Preferred monoethylenically unsaturated monomers containing an acid group are acrylic acid, methacrylic acid, ethacrylic acid, a-chloroacrylic acid, a-cyanoacrylic acid, p-methylacrylic acid (crotonic acid), a-phenylacrylic acid, p-acryloyloxypropionic acid, sorbic acid, a-chlorosorbic acid, 2′-methylisocrotonic acid, cinnamic acid, p-chlorocinnamic acid, p-stearylic acid, itaconic acid, citraconic acid, mesacronic acid, glutaconic acid, aconitic acid, maleic acid, fumaric acid, tricarboxyethylene, and maleic anhydride, hydroxyl or amino-containing esters of the above acids, preferably of acrylic or methacrylic acid, such as 2-hydroxyethyl acrylate, N,N-dimethylaminoethyl acrylate, and the analogous derivatives of methacrylic acid, particular preference being given to acrylic acid and also methacrylic acid and preference beyond that to acrylic acid.

In addition to the monoethylenically unsaturated monomer containing an acid group, this polymer may also be based on further comonomers other than the monoethylenically unsaturated monomer containing an acid group. Preferred comonomers are ethylenically unsaturated sulfonic acid monomers, ethylenically unsaturated phosphonic acid monomers, and acrylamides, preferably.

Ethylenically unsaturated sulfonic acid monomers are preferably aliphatic or aromatic vinylsulfonic acids or acrylic or methacrylic sulfonic acids. Preferred aliphatic or aromatic vinylsulfonic acids are vinylsulfonic acid, allylsulfonic acid, 4-vinylbenzylsulfonic acid, vinyltoluenesulfonic acid, and styrenesulfonic acid. Preferred acryloyl- and methacryloylsulfonic acids are sulfoethyl acrylate, sulfoethyl methacrylate, sulfopropyl acrylate, sulfopropyl methacrylate, 2-hydroxy-3-methacryloyloxypropylsulfonic acid, and 2-acrylamido-2-methylpropanesulfonic acid.

Ethylenically unsaturated phosphonic acid monomers such as vinylphosphonic acid, allylphosphonic acid, vinylbenzylphosphonic acid, acrylamidoalkylphosphonic acid, acrylamidoalkyldiphosphonic acids. Phosphonomethylated vinylamines, (meth)acryloylphosphonic acid derivatives.

Possible acrylamides are alkyl-substituted acrylamides or aminoalkyl-substituted derivatives of acrylamide or of methacrylamide, such as N-vinylamides, N-vinylformamides, N-vinylacetamides, N-vinyl-N-methylacetamides, N-vinyl-N-methylformamides, N-methylol(meth)acrylamide, vinylpyrrolidone, N,N-dimethylpropylacrylamide, dimethylacrylamide or diethylacrylamide, and the corresponding methacrylamide derivatives, and also acrylamide and methacrylamide, preference being given to acrylamide.

In addition it is also possible for the following ethylenically unsaturated monomers to be included: these include, among others, nitriles of (meth)acrylic acid, and other nitrogen-containing methacrylates, such as methacryloylamidoacetonitrile, 2-methacryloyloxyethylmethylcyanamide, cyanomethyl methacrylate; carbonyl-containing methacrylates, such as oxazolidinylethyl methacrylate, N-(methacryloyloxy)formamide, acetonyl methacrylate, N-methacryloylmorpholine, N-methacryloyl-2-pyrrolidonone; glycol dimethacrylates, such as 1,4-butanediol methacrylate, 2-butoxyethyl methacrylate, 2-ethoxyethoxymethyl methacrylate, 2-ethoxyethyl methacrylate, methacrylates of ether alcohols, such as tetrahydrofurfuryl methacrylate, vinyloxyethoxyethyl methacrylate, methoxyethoxyethyl methacrylate, 1-butoxypropyl methacrylate, 1-methyl-(2-vinyloxy)ethyl methacrylate, cyclohexyloxymethyl methacrylate, methoxymethoxyethyl methacrylate, benzyloxymethyl methacrylate, furfuryl methacrylate, 2-butoxyethyl methacrylate, 2-ethoxyethoxymethyl methacrylate, 2-ethoxyethyl methacrylate, allyloxymethyl methacrylate, 1-ethoxybutyl methacrylate, methoxymethyl methacrylate, 1-ethoxyethyl methacrylate, ethoxymethyl methacrylate; oxiranyl methacrylates, such as 2,3-epoxybutyl methacrylate, 3,4-epoxybutyl methacrylate, glycidyl methacrylate; phosphorus-, boron- and/or silicon-containing methacrylates, such as 2-(dimethylphosphato)propyl methacrylate, 2-(ethylenephosphito)propyl methacrylate, dimethylphosphinomethyl methacrylate, dimethylphosphonoethyl methacrylate, diethyl methacryloylphosphonate, dipropyl methacryloyl phosphate; sulfur-containing methacrylates, such as ethylsulfinylethyl methacrylate, 4-thiocyanatobutyl methacrylate, ethylsulfonylethyl methacrylate, thiocyanatomethyl methacrylate, methylsulfinylmethyl methacrylate, and bis(methacryloyloxyethyl)sulfide;

vinyl esters, such as vinyl acetate;

styrene, substituted styrenes with an alkyl substituent in the side chain, such as *methylstyrene and *ethylstyrene, for example, substituted styrenes with an alkyl substituent on the ring, such as vinyltoluene and p-methylstyrene;

heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazol, 3-vinylcarbazol, 4-vinylcarbazol, 1-vinylimidazol, 2-methyl-1-vinylimidazol, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;

vinyl and isoprenyl ethers;

maleic acid derivatives, such as diesters of maleic acid, the alcohol residues having 1 to 9 carbon atoms, maleic anhydride, methylmaleic anhydride, maleimide, and methylmaleimide;

fumaric acid derivatives, such as diesters of fumaric acid, the alcohol residues having 1 to 9 carbon atoms;

α-olefins such as ethene, propene, n-butene, isobutene, n-pentene, isopentene, n-hexene, isohexene; cyclohexene.

In addition it has been found that by means of corresponding monomers it is possible to bring about, in addition to the ionic repulsion, the steric repulsion of the polymeric formations as well. This leads to an additional stabilization of the polymeric formations in the dispersion and the construction mixture.

In accordance with the invention it is therefore also possible to use free-radically polymerizable monomers having a molar mass of greater than 200 g/mol which carry a hydrophilic radical. Particular preference is given to monomers which carry a polyethylene oxide block having two or more units of ethylene oxide. Preference is given to using monomers from the group of (meth)acrylic esters of methoxypolyethylene glycol CH₃O(CH₂CH₂O)ₙH, (with n=2), (meth)acrylic esters of an ethoxylated C16-C18 fatty alcohol mixture (with 2 or more ethylene oxide units), methacrylic esters of 5-tert-octylphenoxypolyethoxyethanol (with 2 or more ethylene oxide units), nonylphenoxypolyethoxyethanol (with 2 or more ethylene oxide units) or mixtures thereof.

Crosslinking may take place both during the preparation of the polymeric formations and thereafter.

The first crosslinking takes place by means of a chemical crosslinker or by means of thermal crosslinking or radiation crosslinking or mixtures thereof, preference being given to treatment by a chemical crosslinker. It serves for the stabilization of the microparticles and is a fundamental prerequisite for swellability.

The chemical crosslinking is achieved by means of crosslinkers which are common knowledge for the skilled worker. Crosslinkers of this kind are used preferably in amounts of less than 20%, more preferably of less than 10%, and most preferably of less than 5% by weight, based on the total weight of the monomers employed.

Inventively preferred crosslinkers are polyacrylic or methacrylic esters, which are obtained, for example, through the reaction of a polyol or ethoxylated polyol such as ethylene glycol, propylene glycol, trimethylolpropane, 1,6-hexanediol-glycerol, pentaerythritol, polyethylene glycol or polypropylene glycol with acrylic acid or methacrylic acid. Use may also be made of polyols, amino alcohols and also their mono(meth)acrylic esters, and monoallyl ethers. Additionally there are also acrylic esters of monoallyl compounds of the polyols and amino alcohols. In this context reference is made to DE 195 43 366 and DE 195 43 368. The disclosures are incorporated here by reference and so considered part of the present disclosure content. Another group of crosslinkers is obtained through the reaction of polyalkylenepolyamines such as diethylenetriamine and triethylenetetraaminemethacrylic acid or methacrylic acid. Suitable crosslinkers include 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethoxylated bisphenol A diacrylate, ethoxylated bisphenol A dimethacrylate, ethylene glycol dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol diacrylate, tetraethylene glycol dimethacrylate, dipentaerythritol pentaacrylate, pentaerythritol tetraacrylate, pentaerythritol triacrylate, trimethylolpropane triacrylate, trimethylol trimethacrylate, tris(2-hydroxyethyl)-isocyanorate triacrylate, tris(2-hydroxy)isocyanorate trimethacrylate, divinyl esters of polycarboxylic acids, diallyl esters of polycarboxylic acids, triallyl terephthalate, diallyl maleate, diallyl fumarate, hexamethylenebismaleimide, trivinyl trimellitate, divinyl adipate, diallyl succinate, and ethylene glycol divinyl ether, cyclopentadiene diacrylate, triallylamine, tetraallylammonium halides, divinylbenzene, divinyl ether, N,N′-methylenbisacrylamide, N,N′-methylenbismethacrylamide, ethylene glycol dimethacrylate, and trimethylolpropane triacrylate. Crosslinkers preferred among these are N,N′-methylenebisacrylamide, N,N′-methylenebismethacrylamide, polyethylene glycol diacrylate, polyethylene glycol dimethacrylate, and triallylamine.

In addition it is possible for subsequent crosslinking to take place. This is done by way of the acid groups and allows the surface of the polymeric formation to be functionalized (intramolecular reaction) and/or leads to covalent linking of individual polymeric formations (intermolecular reaction). The former leads to a compacting of the surface and reduces the number of free acid groups on the surface. This is advantageous in order to allow optimum interaction with the matrix of the construction mixture to be set. The latter makes it possible by means of a simple synthesis step to prepare in a controlled way, from the existing polymeric formations, larger polymeric formations, which, however, are still always smaller than those described in the prior art. Crosslinkers of this kind are used preferably in an amount of less than 30%, more preferably of less than 15%, and most preferably of less than 10% by weight, based on the overall weight of the monomers employed.

Particularly suitable as what are known as “postcrosslinkers” for the first treatment are organic carbonates, polyquaternary amines, polyvalent metal compounds, and compounds having at least two functional groups which are able to react with carboxyl groups of the polymeric formation. These are, in particular, polyols and amino alcohols such as ethylene glycol, diethylene glycol, triethylene glycol, tetraethylene glycol, polyethylene glycol, glycerol, polyglycerol, propylene glycol, ethanolamine, diethanolamine, triethanolamine, propanolamine, polyoxypropylene, oxyethylene-oxypropylene block polymers, sorbitan fatty acid esthers, polyoxyethylenesorbitan fatty acid esthers, trimethylolpropanepentererithritol, polyvinyl alcohol- and sorbitol, polyglycidyl ether compounds, such as ethylene glycol diglycidyl ether, polyethylene glycol diglycidyl ether, glycerol diglycidyl ether, glycerol polyglycidyl ether, pentererithritol polyglycidyl ether, propylene glycol diglycidyl ether, and polypropylene glycol diglycidyl ether, polyaceridine compounds, such as 2,2-bishydroxymethylbuntanol tris[3-(1-aceredinyl)propionate], 1,6-hexamethylenediethylene-urea and diphenylmethane-bis-4,4′-N,N′-diethyleneurea; haloepoxy compounds such as ethylenediamine, diethylenetrialmine, triethylenetetraamine, tetraethylenepentaamine, pentaethylenehexaamine, and polyethylenemines, polyisocyanate compounds such as 2,4-tolylene diisocyanate and hexamethylene diisocyanate, zinc hydroxides, halides of calcium, of aluminum, of iron, of titanium, and of zirconium, alkylene carbonates such as 1,3-dioxalan-2-one and 4-methyl-1,3-dioxalan-2-one. polyvalent metal compounds such as salts, polyquaternary amines such as condensation products of dimethylamines and epichlorohydrin, homopolymers and copolymers of diallyldimethylammonium chloride and homopolymers and copolymers of diethylallylamino(meth)acrylatomethyl chloride ammonium salts. Preferred among these compounds are diethylene glycol, triethylene glycol, polyethylene glycol, glycerol, polyglycerol, propylene glycol, diethanolamine, triethanolamine, polyoxypropylene, oxyethyleneoxypropylene block copolymer, sorbitan fatty acid esters, polyoxyethylene sorbitan fatty acid esters, trimethylolpropane, pentererithritol, polyvenyl alcohol, sorbitol, alkylene carbonates such as 1,3-dioxolan-2-one, 1,3-dioxolan-2-one, 4-methyl-1,3-dioxolan-2-one, one, 4,5-dimethyl-1,3-dioxolan-2-one, 4,4-dimethyl-1,3-dioxolan-2-one, 4-ethyl-1,3-dioxolan-2-one, hydroxymethyl-1,3-dioxolan-2-one, 1,3-dioxan-2-one, 4-methyl-1,3-dioxan-2-one, 4,6-dimethyl-1,3-dioxan-2-one, 3-dioxopan-2-one, poly-1,3-dioxolan-2-one, and ethylene glycol diglycidyl ether.

Polyoxazolines such as 1,2-ethylenebisoxazoline, crosslinkers with silane groups such as γ-glycidyloxypropyltrimethoxysilane and γ-aminopropyltrimethoxysilane, oxazolidinones such as 2-oxazolidinone, bis- and poly-2-oxazolidinones, diglycol silicates. Among the aforementioned postcrosslinkers, ethylene carbonate is particularly preferred.

During the emulsion polymerization or thereafter it is possible for water-soluble polymers to be employed for the purpose of additional stabilization. Examples thereof are water-soluble homopolymers or copolymers of the aforementioned monomers, such as polyacyrlic acid, partly saponified polyvinyl acetate, polyvinyl alcohol, polyalkylene glycol, starch, starch derivatives, graft-polymerized starch, cellulose and cellulose derivatives, such as carboxymethylcellulose, hydroxymethylcellulose, and also galactomanans and oxalkylated derivatives thereof.

The polymeric formations are swollen by bases. This swelling is synonymous with a deprotonation of the acid groups in the polymeric formation. Swelling may take place during the emulsion polymerization, thereafter in the dispersion and/or in the construction mixture, which the skilled worker knows to be basic. Suitable bases, besides the construction mixture, are the alkali metal hydroxides, ammonia, and the aliphatic primary and secondary amines, and also alkali metal carbonates and alkali metal hydrogen carbonates. Preference is given to the alkali metal hydroxides sodium hydroxide and potassium hydroxide and also to NH₃, NH₄OH, and soda.

The polymeric formations of the invention can be prepared preferably by emulsion polymerization and preferably have an average particle size of 10 to 10 000 nm; an average particle size of 50 to 5000 nm is particularly preferred. Most preferable are average particle sizes of 80 to 1000 nm.

For the preparation of the polymeric formations of the invention it is possible to employ all of the initiators and regulators that are customary for emulsion polymerization. Examples of initiators are inorganic peroxides, organic peroxides or H₂O₂, and also mixtures thereof with, if appropriate, one or more reducing agents.

In accordance with the invention it is possible to employ any ionic or nonionic emulsifier during or after the preparation of the dispersion.

In the case of preparation by emulsion polymerization the microparticles are obtained in the form of an aqueous dispersion. Accordingly, the addition of the microparticles to the building material mixture preferably takes place likewise in this form.

Through bimodal particle distribution it is possible to achieve an optimum combination of properties in respect of reduced self-dryout and improved frost resistance and cyclical freeze/thaw durability. In this context the first property is determined in particular by large polymeric formations, especially those known through the prior art, the latter by means of the polymeric formations of the invention. A preferred system is achieved through mixtures of polymeric formations having a diameter of between 10 nm and 500 μm, at least one of the sorts of polymeric formations contained in the mixture having a diameter of less than 1000 nm.

The average particle size is determined, for example, by counting a statistically significant amount of particles by means of transmission electron micrographs.

The polymeric formations are added to the building material mixture in a preferred amount of 0.01% to 5% by volume, in particular 0.1% to 0.5% by volume. The building material mixture, in the form for example of concrete or mortar, may in this case include the customary hydraulically setting binders, such as cement, lime, gypsum or anhydrite, for example.

Through the use of the polymeric formations of the invention it is possible to keep the air introduced into the building material mixture at an extraordinarily low level.

Higher compressive strengths are of interest, in addition and in particular, insofar as it is possible to reduce the cement content of the concrete, which is needed for strength to develop, as a result of which it is possible to achieve a significant lowering in the price per m³ of concrete.

1. Use of polymeric formations in hydraulically setting building material mixtures, characterized in that polymeric formations which are swollen using a base and which comprise one or more crosslinkers and also one or more monoethylenically unsaturated monomers are used.

2. Use of polymeric formations according to claim 1, characterized in that the bases are selected from the group of amines, alkali metal compounds and alkaline earth metal compounds.

3. Use of polymeric formations according to claim 2, characterized in that the bases are NH₃, NaOH or NH₄OH.

4. Use of polymeric formations according to claim 2, characterized in that swelling takes place in the basic construction mixture.

5. Use of polymeric formations according to claim 1, characterized in that the monoethylenically unsaturated monomers are selected from the group of monomers containing an acid group.

6. Use of polymeric formations according to claim 1, characterized in that emulsifiers are used.

7. Use of polymeric formations according to claim 1, characterized in that polymeric formations of different size are used.

8. Use of polymeric formations according to claim 7, characterized in that polymeric formations of different size, with a diameter of between 10 nm and 500 μm, at least one of the sorts of polymeric formations included in the mixture having a diameter of less than 1000 nm, are included.

9. Use of polymeric formations according to claim 1, characterized in that the polymeric formations have an average particle size of 10 to 10 000 nm.

10. Use of polymeric formations according to claim 9, characterized in that the microparticles have an average particle size of 50 to 5000 nm.

11. Use of polymeric formations according to claim 10, characterized in that the microparticles have an average particle size of 80 to 1000 nm.

12. Use of polymeric formations according to claim 1, characterized in that water-soluble polymers are used.

13. Use of polymeric formations according to claim 1, characterized in that the polymeric formations are used in an amount of 0.01% to 5% by volume, based on the building material mixture.

14. Use of polymeric formations according to claim 1, characterized in that the building material mixtures are composed of a binder selected from the group of cement, lime, gypsum and anhydrite.

15. Use of polymeric formations according to claim 1, characterized in that the building material mixtures are concrete or mortar.
